(19) United States
(12) Patent Application Publication
(10) Pub. No.: US 2018/0354362 A1
(43) Pub. Date: Dec. 13, 2018

(54) VEHICLE ACCELERATOR PEDAL FORCE SYSTEM, AND METHODS OF USE AND MANUFACTURE THEREOF

(71) Applicant: Honda Motor Co., Ltd., Tokyo (JP)

(72) Inventors: Yoshinori KUNIMURA, Dublin, OH (US); Akihiko KOIKE, Dublin, OH (US); Ayumu YAMAGUCHI, Utsunomiya (JP)

(21) Appl. No.: 15/619,241

(22) Filed: Jun. 9, 2017

(51) Int. Cl. B60K 26/02; G05G 1/44; G05G 5/03

(52) U.S. Cl. CPC B60K 26/021; B60K 2026/022; G05G 5/03; G05G 1/44

(57) ABSTRACT

An accelerator pedal assembly of a vehicle can include a pivotable arm including a moveable end that is movable through a plurality of pedal positions from an initial position to a fully engaged position. The accelerator pedal assembly can also include a pedal connected to the moveable end of the pivotable arm. The accelerator pedal assembly can further include a reaction force control assembly connected to the pivotable arm and configured to apply a reaction force to the pivotable arm. The reaction force control assembly can include a first mode in which the reaction force increases as the pedal position approaches the fully engaged position in accordance with a first relationship, and a second mode in which the reaction force increases as the pedal position approaches the fully engaged position in accordance with a second relationship that is different from the first relationship.

### BACKGROUND

The disclosed subject matter relates to vehicle accelerator pedal force systems, and methods of use and manufacture thereof. More particularly, the disclosed subject matter relates to methods and apparatus that produce pedal reaction forces to provide tactile feedback to the driver via the accelerator pedal.

Accelerator pedals, particularly those incorporated in pedal force systems, enhance driver experience by providing altered pedal resistance tailored to vehicle parameters. Altered pedal resistance is used to modulate heavier or lighter pedal effort for the driver to press the accelerator pedal and cause the vehicle to accelerate. Heavier pedal effort can discourage the driver from further pressing the accelerator pedal, while lighter pedal effort can encourage the driver to press the accelerator pedal more depending on the vehicle parameters.

### SUMMARY

According to one aspect, an accelerator pedal assembly of a vehicle can include a pivotable arm including a moveable end that is movable through a plurality of pedal positions from an initial position to a fully engaged position. The accelerator pedal assembly can also include a pedal connected to the moveable end of the pivotable arm. The accelerator pedal assembly can further include a reaction force control assembly connected to the pivotable arm and configured to apply a reaction force to the pivotable arm. The reaction force control assembly can include a first mode in which the reaction force increases as the pedal position approaches the fully engaged position in accordance with a first relationship, and a second mode in which the reaction force increases as the pedal position approaches the fully engaged position in accordance with a second relationship that is different from the first relationship, and the second relationship is based on a driver positioning setting.

According to yet another aspect, an accelerator pedal assembly of a vehicle can include a pivotable arm including a moveable end that is movable through a plurality of pedal positions from an initial position to a fully engaged position. The accelerator pedal assembly can also include a pedal connected to the moveable end of the pivotable arm. The accelerator pedal assembly can further include a reaction force control assembly connected to the pivotable arm and configured to apply a reaction force to the pivotable arm. The reaction force control assembly can include a first mode in which the reaction force increases as the pedal position approaches the fully engaged position in accordance with a first relationship, and a second mode in which the reaction force increases as the pedal position approaches the fully engaged position in accordance with a second relationship that is different from the first relationship, and the second relationship is based on a selectable autonomous or semi-autonomous setting of the vehicle.

According to yet another aspect, an accelerator pedal assembly of a vehicle can include a pivotable arm including a moveable end that is movable through a plurality of pedal positions from an initial position to a fully engaged position. The accelerator pedal assembly can also include a pedal connected to the moveable end of the pivotable arm. The accelerator pedal assembly can further include a reaction force control assembly connected to the pivotable arm and configured to apply a reaction force to the pivotable arm. The reaction force control assembly can include a first mode in which the reaction force increases as the pedal position approaches the fully engaged position in accordance with a first relationship, and a second mode in which the reaction force increases as the pedal position approaches the fully engaged position in accordance with a second relationship that is different from the first relationship, and the second relationship is based on a dynamic vehicle condition.

According to yet another aspect, an accelerator pedal assembly of a vehicle can include a pivotable arm including a moveable end that is movable through a plurality of pedal positions from an initial position to a fully engaged position. The accelerator pedal assembly can also include a pedal connected to the moveable end of the pivotable arm. The accelerator pedal assembly can further include a reaction force control assembly connected to the pivotable arm and configured to apply a reaction force to the pivotable arm. The reaction force can be defined by a first rate of increase for a first range of predetermined pedal positions, followed by a second rate of increase that is greater than the first rate for a second range of predetermined pedal positions that is closer to the fully engaged position than the first range.

According to yet another aspect, an accelerator pedal assembly of a vehicle can include a pivotable arm including a moveable end that is movable through a plurality of pedal positions from an initial position to a fully engaged position. The accelerator pedal assembly can also include a pedal connected to the moveable end of the pivotable arm. The accelerator pedal assembly can further include a reaction force control assembly connected to the pivotable arm and configured to apply a reaction force to the pivotable arm. The reaction force control assembly can include a first mode in which the reaction force increases as the pedal position approaches the fully engaged position in accordance with a first relationship, and a second mode in which the reaction force increases as the pedal position approaches the fully engaged position in accordance with a second relationship that is different from the first relationship, and the second relationship is based on a selectable sport setting of the vehicle and is defined by a first rate of increase for a first range of predetermined pedal positions, followed by a second rate of increase that is less than the first rate of increase for a second range of predetermined pedal positions that is closer to the fully engaged position than the first range.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a schematic view of an embodiment of an accelerator pedal assembly for a vehicle in accordance with the disclosed subject matter.

FIG. 2 is a schematic view of an alternate embodiment of the accelerator pedal assembly.

FIG. 3 is a schematic view of another alternate embodiment of the accelerator pedal assembly.

FIG. 4 is a graph depicting a plot of a baseline pedal force versus pedal stroke of the accelerator pedal assembly.

FIG. 5 is a graph depicting a plot of a decreased pedal force of the accelerator pedal assembly against the baseline of FIG. 4.

FIG. 6 is a graph depicting a plot of an increased pedal force of the accelerator pedal assembly against the baseline of FIG. 4.

FIG. 7 is a side view of an exemplary vehicle equipped with an embodiment of the accelerator pedal assembly ascending an incline surface.

FIG. 8 is a graph depicting a plot of pedal force versus pedal stroke of the accelerator pedal assembly of FIG. 7.

FIG. 9 is a plan view of an exemplary vehicle equipped with an embodiment of the accelerator pedal assembly following a curved path.

FIG. 10 is a graph depicting a plot of pedal force versus pedal stroke of the accelerator pedal assembly of FIG. 9.

FIG. 11 is a graph depicting a plot of a pedal force versus pedal stroke of the accelerator pedal assembly.

FIG. 12 is a graph depicting a plot of a pedal force versus pedal stroke of the accelerator pedal assembly.

FIG. 13 is a graph depicting a plot of a pedal force versus pedal stroke of the accelerator pedal assembly.

FIG. 14 is a graph depicting a plot of a pedal force versus pedal stroke of the accelerator pedal assembly.

FIG. 15 is a graph depicting a plot of a pedal force versus pedal stroke of the accelerator pedal assembly.

FIG. 16 is a graph depicting a plot of a pedal force versus pedal stroke of the accelerator pedal assembly.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

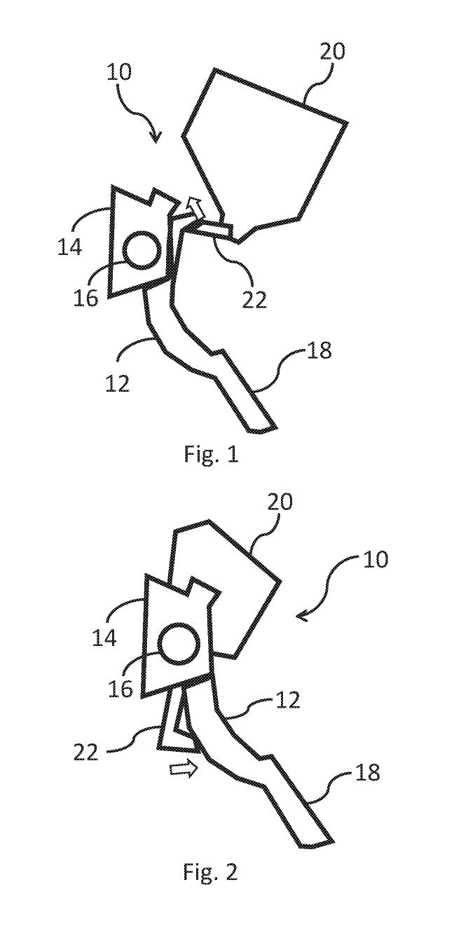

FIG. 1 illustrates an embodiment of an accelerator pedal assembly 10 for a vehicle in accordance with the disclosed subject matter. The accelerator pedal assembly 10 can include an arm 12 rotatably connected to a mounting structure 14 via a pin 16. The accelerator pedal assembly 10 can also include a pedal 18 connected to a movable end of the arm 12 that is configured to pivot through pedal positions as the arm 12 rotates about the mounting structure 14. The accelerator pedal assembly 10 can also include a reaction force module 20 that engages a pivoting end of the arm 12 via a linkage 22. As will be described below, the reaction force module 20 serves to apply force to the pedal 18 in a direction opposing that which the pedal 18 is pressed by an operator. Force applied by the force module 20 thus increases the pressing force an operator must use to move the pedal 18.

In the embodiment of the accelerator pedal assembly 10 shown in FIG. 1, the reaction force module 20 can be spaced from the mounting structure 14. The linkage 22 can thereby extend from a portion of the mounting structure 14 proximate the pivoting end of the arm 12 to contact the pivoting end.

During operation of the vehicle, the operator (driver) can exert a force on the pedal 18, such as by pressing the pedal 18 with one's foot, to urge the movable end of the arm 12 and the connected pedal 18 to pivot to a lower pedal position to cause the vehicle to accelerate. For example, in a vehicle with a combustion engine, pivoting the pedal 18 to a lower pedal position can open a throttle of the engine to increase torque for acceleration. A lower pedal position is defined as a position in which the pedal 18 is brought closer to a forward or lower footwell surface of the vehicle. In other words, the pedal 18 is farther from the operator in a lower pedal position. The pedal 18 can move through a range of pedal positions between an initial position and a fully engaged position. In the initial position, the pedal 18 is not pressed at all and is at the pedal position closest to the operator in the range (i.e., farther from the forward or lower footwell surface of the vehicle). In the fully engaged position, the pedal 18 is fully pressed and is at the pedal position farthest from the operator in the range (i.e., closest to the forward or lower footwell surface of the vehicle).

In this configuration, the force module 20 can exert a pedal reaction force on the linkage 22 that is transferred to the pivoting end of the arm 12 so as to urge the movable end of the arm 12 and the connected pedal 18 to pivot to a higher pedal position, thereby causing an increase in pedal effort required by the operator. F to close the throttle of the vehicle for deceleration. As described above, a higher pedal position is defined as a position in which the pedal 18 is spaced farther from the forward or lower footwell surface of the vehicle and is closer to the operator.

Both of the above described forces exerted on the arm 12 determine a resulting pedal position of the moveable end of the arm 12 and the pedal 18, such that the resulting pedal position is the net of the force exerted by the force module 20 and the force exerted by the operator pressing down on the pedal 18. The resulting pedal position yields a predetermined torque output of the vehicle, thereby inducing acceleration, deceleration or maintaining a speed.

FIG. 2 illustrates an alternate embodiment of the accelerator pedal assembly 10. The embodiment shown in FIG. 2 includes the force module 20 in close proximity to the mounting structure 14, and the linkage 22 extending from the force module 20 downward beyond the mounting structure 14. The linkage 22 extends along a portion of the arm 12 below the pin 16 and is approximately L-shaped such that a lower leg of the linkage 22 is configured to contact the arm 12. Specifically, the lower leg of the linkage 22 is configured to contact an intermediate portion of the arm 12 from a forward direction (back side of the arm 12) to urge the arm 12, and the pedal 18, to a higher pedal position, necessitating increased pedal effort on behalf of the operator to press the pedal 18 and the arm 12 to a lower pedal position.

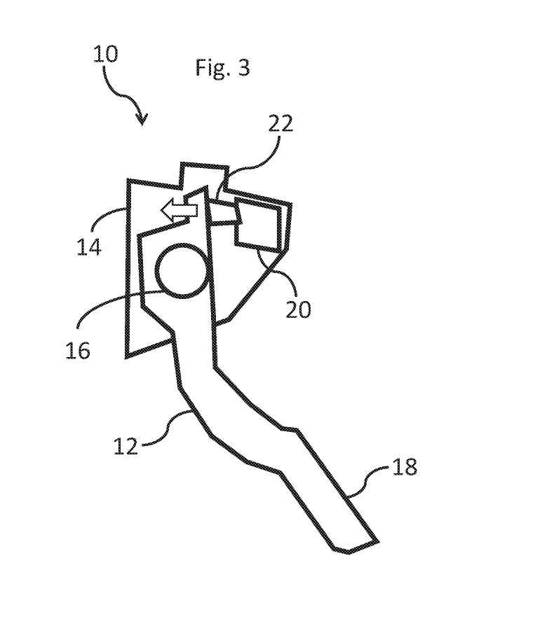

FIG. 3 illustrates another alternate embodiment of the accelerator pedal assembly 10. The embodiment shown in FIG. 3 includes the force module 20 as part of the mounting structure 14, and the linkage 22 configured to transfer force from the force module 20 to the arm 12 also contained therein. The arm 12 can include a protrusion at an opposite end from the pedal 18 at the moveable end of the arm 12 which is contacted by the linkage 22. The force module 20, via the linkage 22, can urge the protrusion of the arm 12 forward and thereby cause a portion of the arm below the pin 16 to rotate rearward. Thus, the arm 12 and the pedal 18 can be urged rearward and closer to the operator by the force module 20 pressing the protrusion of the arm 12 forward under the reaction force.

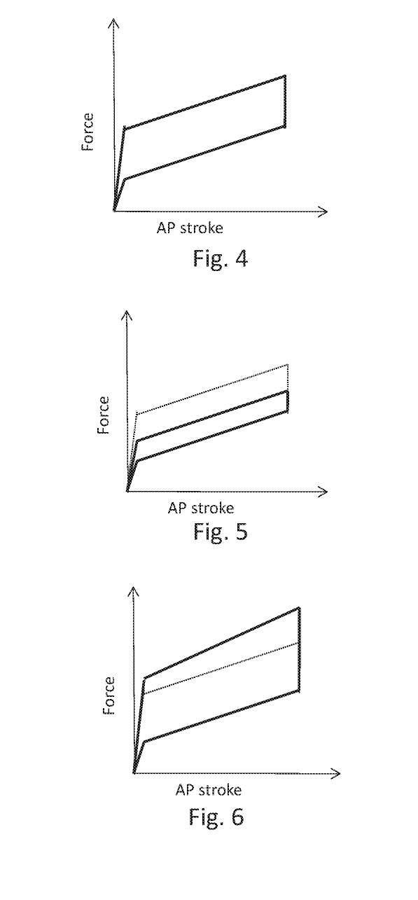

FIG. 4 is a graph depicting a plot of a baseline pedal force versus pedal stroke of the accelerator pedal assembly 10. In FIG. 4, AP (accelerator pedal) stroke is plotted against reaction force to show increases in reaction force by the force module 20 of the accelerator pedal assembly 10 as the arm 12 and the pedal 18 move through the various pedal positions between initial and fully engaged positions. As shown, initial stroke of the pedal 18 has a relative high reaction force slope to avoid erroneous or unintentional pressing of the pedal 18, followed by a decreased reaction force slope once the operator has surpassed the pedal positions indicative of intentional acceleration. The plot includes upper and lower slopes to portray both pressing and releasing the pedal 18, for instances covering operator intended acceleration as well as deceleration. As will be described below, FIG. 4 portrays the baseline pedal force versus pedal stroke of the accelerator pedal assembly 10 to which various embodiments of the accelerator pedal assembly 10 will be compared.

FIG. 5 is a graph depicting a plot of a decreased pedal force of the accelerator pedal assembly 10 against the baseline of FIG. 4. In FIG. 5, AP (accelerator pedal) stroke is plotted against reaction force to show increases in reaction force by the force module 20 of the accelerator pedal assembly 10 as the arm 12 and the pedal 18 move through the various pedal positions between initial and fully engaged positions. As shown, the graph in FIG. 5 shows a decreased reaction force compared with the baseline plot of FIG. 4 to reflect less pedal effort required by the operator to increase torque output of the vehicle. The decreased reaction force can encourage the operator to press the pedal 18 by providing less resistance, thereby resulting in increased torque output for acceleration. As will be described below, decreased reaction force resulting in less pedal effort required by the operator may be desirable and/or beneficial under various circumstances.

FIG. 6 is a graph depicting a plot of an increased pedal force of the accelerator pedal assembly 10 against the baseline of FIG. 4. In FIG. 6, AP (accelerator pedal) stroke is plotted against reaction force to show increases in reaction force by the force module 20 of the accelerator pedal assembly 10 as the arm 12 and the pedal 18 move through the various pedal positions between initial and fully engaged positions. As shown, the graph in FIG. 6 shows an increased reaction force compared with the baseline plot of FIG. 4 to reflect more pedal effort required by the operator to increase torque output of the vehicle. The increased reaction force can discourage the operator from pressing the pedal 18 by providing more resistance, thereby resulting in maintained or decreased torque output for maintaining speed or deceleration. As will be described below, increased reaction force resulting in more pedal effort required by the operator may be desirable and/or beneficial under various circumstances.

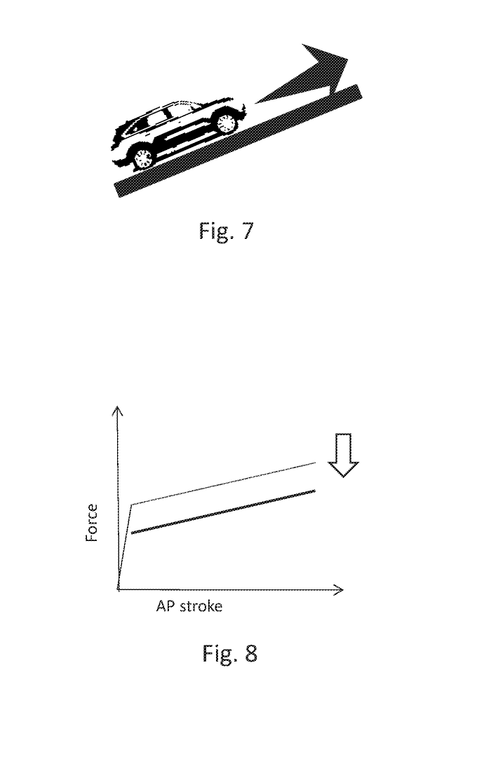

FIG. 7 is a side view of an exemplary vehicle equipped with an embodiment of the accelerator pedal assembly 10 ascending an incline surface. In FIG. 7, the vehicle is shown on the incline surface traveling in a direction designated by the arrow (uphill). As will be described below, the graph shown in FIG. 8 represents a map of the accelerator pedal assembly 10 configured for the vehicle during hill climbs.

FIG. 8 is a graph depicting a plot of pedal force versus pedal stroke of the accelerator pedal assembly 10 of FIG. 7. In FIG. 8, the reaction force control assembly 10 has a first mode and second mode of operation. In the first mode, the reaction force increases as the pedal position approaches the fully engaged position in accordance with a first relationship. The first relationship of the pedal force and pedal stroke can be the baseline plot shown in FIG. 4 and described above. In the second mode, the reaction force increases as the pedal position approaches the fully engaged position in accordance with a second relationship. The second relationship of the pedal force and pedal stroke can be a decreased/reduced reaction force applied to the arm 12 for corresponding pedal positions versus the first relationship (i.e., the baseline). The accelerator pedal assembly 10 can operate in the second mode when the vehicle is ascending an incline, such that upon driving the vehicle and encountering an incline, the accelerator pedal assembly 10 switches from the first mode to the second mode to decrease/reduce the pedal effort required by the driver to maintain or increase torque output. By decreasing/reducing the pedal effort, the accelerator pedal assembly 10 encourages the driver to press the pedal 18 further to maintain or increase torque output and thereby maintain or increase vehicle speed. Once the vehicle has progressed past the incline surface, the accelerator pedal assembly 10 can switch from the second mode back to the first mode for normal pedal effort associated with driving on level or downhill surfaces.

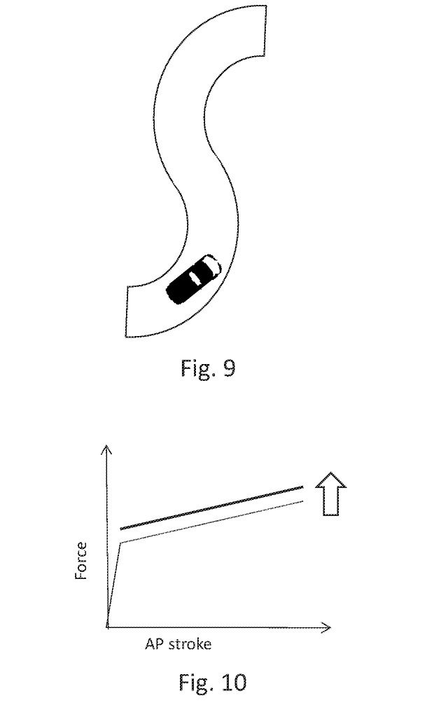

FIG. 9 is a plan view of an exemplary vehicle equipped with an embodiment of the accelerator pedal assembly 10 following a curved path. In FIG. 9, the vehicle is shown traveling around a curve/bend. As will be described below, the graph shown in FIG. 10 represents a map of the accelerator pedal assembly 10 configured for the vehicle during curves/bends.

FIG. 10 is a graph depicting a plot of pedal force versus pedal stroke of the accelerator pedal assembly of FIG. 9. In FIG. 10, the reaction force control assembly 10 has a first mode and second mode of operation. In the first mode, the reaction force increases as the pedal position approaches the fully engaged position in accordance with a first relationship. The first relationship of the pedal force and pedal stroke can be the baseline plot shown in FIG. 4 and described above. In the second mode, the reaction force increases as the pedal position approaches the fully engaged position in accordance with a second relationship. The second relationship of the pedal force and pedal stroke can be a increased reaction force applied to the arm 12 for corresponding pedal positions versus the first relationship (i.e., the baseline). The accelerator pedal assembly 10 can operate in the second mode when the vehicle is navigating a curve/bend along a path of travel, such that upon driving the vehicle and encountering a curve/bend, the accelerator pedal assembly 10 switches from the first mode to the second mode to increase the pedal effort required by the driver to maintain or increase torque output. By increasing the pedal effort, the accelerator pedal assembly 10 discourages the driver to press the pedal 18 further to maintain or decrease torque output and thereby maintain or decrease vehicle speed. Once the vehicle has progressed past the curve/bend, the accelerator pedal assembly 10 can switch from the second mode back to the first mode for normal pedal effort associated with driving along a straight path of travel.

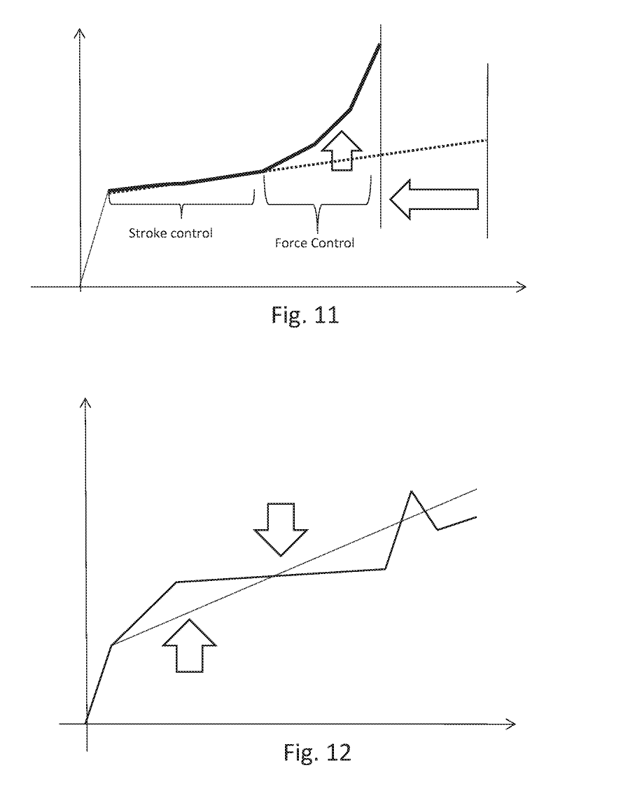

FIG. 11 is a graph depicting a plot of a pedal force versus pedal stroke of the accelerator pedal assembly. In FIG. 11, the accelerator pedal assembly 10 applies a reaction force to the arm 12 by a first rate of increase for a first range of predetermined pedal positions, followed by a second rate of increase that is greater than the first rate for a second range of predetermined pedal positions that is closer to the fully engaged position than the first range. As the pedal position approaches the fully engaged position, an initial range (first range) of pedal positions returns similar, slightly increasing pedal effort. The increase in pedal effort is approximately linear and torque output of the vehicle is primarily affected by pedal position (i.e., stroke) due to the relatively flat plot between stroke and reaction force. A subsequent range (second range) of pedal positions returns greatly increasing pedal effort. The increase in pedal effort is approximately exponential and torque output of the vehicle is primarily affected by pedal effort (i.e., pedal force) due to the sharply inclined plot between stroke and reaction force. This map of the accelerator pedal assembly 10 results in an overall decrease in stroke distance versus other embodiments such as the baseline configuration, shown in FIG. 4. The decrease in stroke distance for the pedal 18 can yield enhanced packaging for the accelerator pedal assembly 10 and other proximate components of the vehicle in the footwell area. Furthermore, this map can result in enhanced driver feel and control of acceleration, deceleration or maintaining speed of the vehicle.

FIG. 12 is a graph depicting a plot of a pedal force versus pedal stroke of the accelerator pedal assembly. In FIG. 12, the reaction force control assembly 10 has a first mode and second mode of operation. In the first mode, the reaction force increases as the pedal position approaches the fully engaged position in accordance with a first relationship. The first relationship of the pedal force and pedal stroke can be the baseline plot shown in FIG. 4 and described above. In the second mode, the reaction force increases as the pedal position approaches the fully engaged position in accordance with a second relationship. The second relationship can be based on a selectable sport setting of the vehicle and is defined by a first rate of increase for a first range of predetermined pedal positions, followed by a second rate of increase that is less than the first rate of increase for a second range of predetermined pedal positions that is closer to the fully engaged position than the first range. The accelerator pedal assembly 10 can operate in the second mode when the vehicle is in a selectable sport setting, such that upon selecting the sport setting, the accelerator pedal assembly 10 switches from the first mode to the second mode. In the second mode, the pedal effort required by the driver to maintain or increase torque output through the first range has a relatively high rate of increase, while the pedal effort required through the second range is approximately constant with little to no rate of increase. By transitioning the pedal effort from a relatively high rate of increase to constant effort, the accelerator pedal assembly 10 transmits a sporty and engaged acceleration feel to the driver upon pressing the pedal 18 to increase or maintain torque output, and/or releasing the pedal 18 to decrease torque output. Once the vehicle has been switched from the sport setting back to a normal operation setting, the accelerator pedal assembly 10 can switch from the second mode back to the first mode for normal pedal effort.

The map of the accelerator pedal assembly 10 of FIG. 12 can also include a third rate of increase that is greater than the second rate of increase for a third range of predetermined pedal positions that is closer to the fully engaged position than the second range. This third range of pedal positions can be near the fully engaged pedal position and movement of the pedal 18 through this range can result in a shift of gear in the transmission. The third range of pedal positions has the third rate of increase to signal to the operator that the vehicle will shift gears if the pedal 18 is pressed further. By increasing the pedal effort required to move the pedal 18 through the third range of pedal positions, the map conveys to the operator where in the range of pedal positions a gear shift will occur, so as to avoid unintentional gear shifts. As described above, once the vehicle has been switched from the sport setting back to a normal operation setting, the accelerator pedal assembly 10 can switch from the second mode back to the first mode for normal pedal effort.

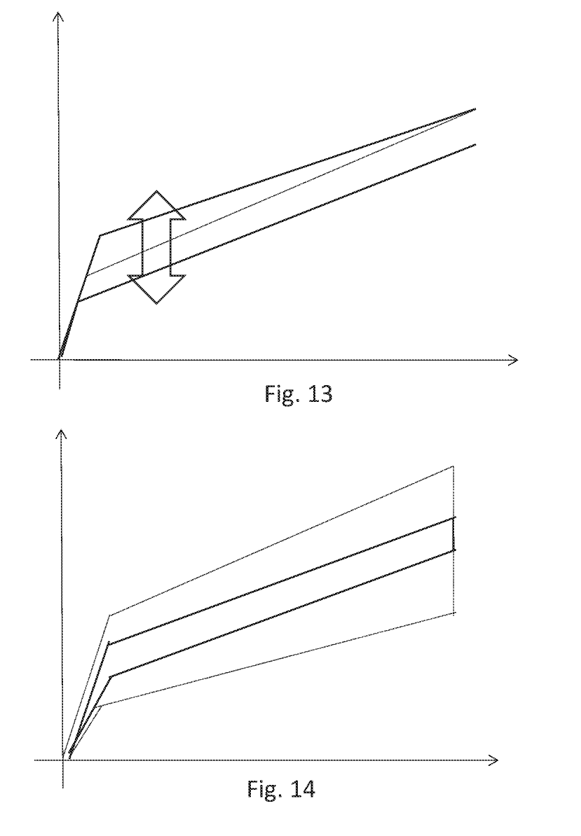

FIG. 13 is a graph depicting a plot of a pedal force versus pedal stroke of the accelerator pedal assembly 10. In FIG. 13, the reaction force control assembly 10 has a first mode and second mode of operation. In the first mode, the reaction force increases as the pedal position approaches the fully engaged position in accordance with a first relationship. The first relationship of the pedal force and pedal stroke can be the baseline plot shown in FIG. 4 and described above. In the second mode, the reaction force increases as the pedal position approaches the fully engaged position in accordance with a second relationship. The second relationship of the pedal force and pedal stroke can be a decreased/reduced reaction force applied to the arm 12 for corresponding pedal positions versus the first relationship (i.e., the baseline). The accelerator pedal assembly 10 can operate in the second mode upon adjusting the driver seat height. In other words, upon adjusting the driver seat height, the accelerator pedal assembly 10 switches from the first mode to the second mode to either increasing or decreasing the pedal effort required by the driver to maintain or increase torque output depending on whether the seat height is increased or decreased. By increasing the pedal effort when the seat is raised, the accelerator pedal assembly 10 resists the driver pressing the pedal 18 further to avoid unintentional increases in torque output. On the other hand, by decreasing pedal effort when the seat is lowered, the accelerator pedal assembly 10 eases the driver pressing the pedal 18 further to enable the driver to readily increase torque output of the vehicle. The seat height can be returned to a default height to revert the map of the accelerator pedal assembly 10 to the baseline of FIG. 4, for example.

FIG. 14 is a graph depicting a plot of a pedal force versus pedal stroke of the accelerator pedal assembly. In FIG. 14, the reaction force control assembly 10 has a first mode and second mode of operation. In the first mode, the reaction force increases as the pedal position approaches the fully engaged position in accordance with a first relationship. The first relationship of the pedal force and pedal stroke can be the baseline plot shown in FIG. 4 and described above. In the second mode, the reaction force increases as the pedal position approaches the fully engaged position in accordance with a second relationship. The second relationship of the pedal force and pedal stroke can be an increased reaction force applied to the arm 12 for corresponding pedal positions versus the first relationship (i.e., the baseline). The accelerator pedal assembly 10 can operate in the second mode when the vehicle is traveling beyond a threshold speed, such that upon driving the vehicle above or below the threshold speed, the accelerator pedal assembly 10 switches from the first mode to the second mode to decrease the pedal effort required by the driver to maintain or increase torque output, and/or increase the pedal effort required by the driver to decrease torque output. By increasing the pedal effort, the accelerator pedal assembly 10 encourages the driver to press the pedal 18 further to maintain or increase torque output and thereby maintain or increase vehicle speed, and/or release the pedal 18 to decrease torque output and thereby decrease vehicle speed. Once the vehicle is no longer traveling beyond the threshold speed, the accelerator pedal assembly 10 can switch from the second mode back to the first mode for normal pedal effort associated with the baseline of FIG. 4, for example.

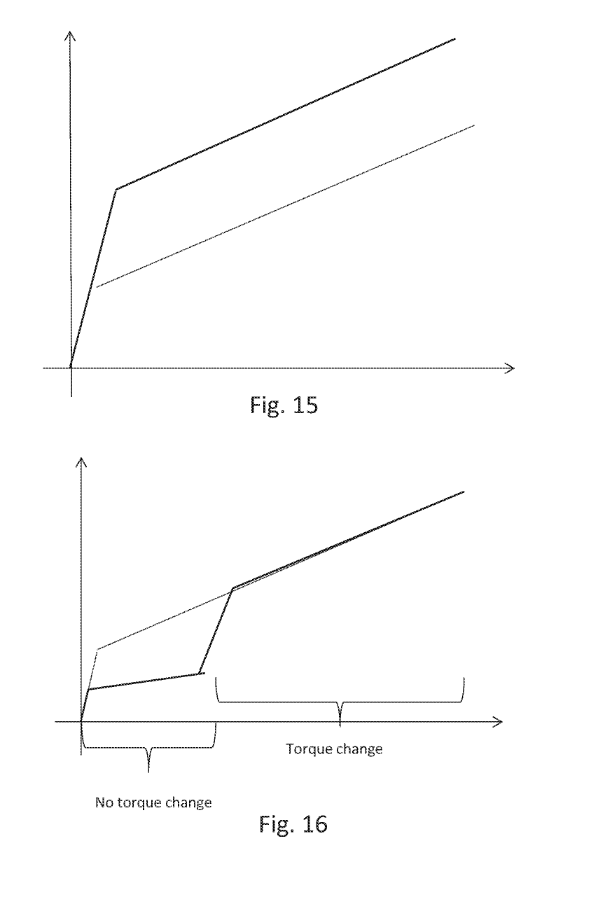

FIG. 15 is a graph depicting a plot of a pedal force versus pedal stroke of the accelerator pedal assembly. In FIG. 15, the reaction force control assembly 10 has a first mode and second mode of operation. In the first mode, the reaction force increases as the pedal position approaches the fully engaged position in accordance with a first relationship. The first relationship of the pedal force and pedal stroke can be the baseline plot shown in FIG. 4 and described above. In the second mode, the reaction force increases as the pedal position approaches the fully engaged position in accordance with a second relationship. The second relationship of the pedal force and pedal stroke can be an increased reaction force applied to the arm 12 for corresponding pedal positions versus the first relationship (i.e., the baseline). The accelerator pedal assembly 10 can operate in the second mode when the vehicle is operating in an autonomous driving mode, such that upon enabling an autonomous driving mode, the accelerator pedal assembly 10 switches from the first mode to the second mode to increase the pedal effort required by the driver to maintain or increase torque output. By increasing the pedal effort, the accelerator pedal assembly 10 discourages the driver from pressing the pedal 18 further to maintain or increase torque output and thereby. This increased reaction force maintains the initial pedal position of the pedal 18 closest the operator such that the pedal 18 can function as a footrest. The operator can rest one's feet on the pedal 18 without the pedal 18 progressing towards the fully engaged pedal position because an increased pedal effort is required to do so. Once the vehicle is no longer operating in the autonomous driving mode, the accelerator pedal assembly 10 can switch from the second mode back to the first mode for normal pedal effort associated with the baseline of FIG. 4, for example.

FIG. 16 is a graph depicting a plot of a pedal force versus pedal stroke of the accelerator pedal assembly. In FIG. 16, the reaction force control assembly 10 has a first mode and second mode of operation. In the first mode, the reaction force increases as the pedal position approaches the fully engaged position in accordance with a first relationship. The first relationship of the pedal force and pedal stroke can be the baseline plot shown in FIG. 4 and described above. In the second mode, the reaction force increases as the pedal position approaches the fully engaged position in accordance with a second relationship. The second relationship can be based on an autonomous cruise control mode of operation of the vehicle and is defined by a first rate of increase for a first range of predetermined pedal positions, followed by a second rate of increase that is greater than the first rate of increase for a second range of predetermined pedal positions that is closer to the fully engaged position than the first range. The accelerator pedal assembly 10 can operate in the second mode when the vehicle is operating in autonomous cruise control, such that upon selecting the auto cruise function, the accelerator pedal assembly 10 switches from the first mode to the second mode. In the second mode, travel of the pedal 18 through the first range of pedal positions results in no torque output change to the vehicle and the vehicle continues operating under auto cruise control. Consequently, the pedal effort required by the driver to progress through the first range is relatively low with little to no rate of increase. On the other hand, travel of the pedal 18 through the second range of pedal positions results in a torque output change to the vehicle and causes the vehicle to cease operating under auto cruise control, thereby returning operation of the accelerator pedal assembly 10 to the baseline map shown in FIG. 4, for example. Consequently, the pedal effort required by the driver to progress through the second range is relatively high with a high rate of increase (slope). By transitioning the pedal effort from relatively low and constant effort to a higher effort and higher rate of increase, the accelerator pedal assembly 10 communicates to the driver that further pressing of the pedal 18 will result in the vehicle disabling autonomous cruise control. Once the autonomous cruise control function of the vehicle has been disable, the vehicle returns to normal operation and the accelerator pedal assembly 10 can then switch from the second mode back to the first mode for normal pedal effort.

While certain embodiments of the invention are described above, and FIGS. 1-16 disclose the best mode for practicing the various inventive aspects, it should be understood that the invention can be embodied and configured in many different ways without departing from the spirit and scope of the invention.

Embodiments are also intended to include or otherwise cover methods of using and methods of manufacturing the accelerator pedal assembly disclosed above. The methods of manufacturing include or otherwise cover processors and computer programs implemented by processors used to design various elements of the accelerator pedal assembly disclosed above. For example, embodiments are intended to cover processors and computer programs used to design or manufacture the force module of the accelerator pedal assembly that provides tactile feedback to the driver based on driver behavior data with regards to acceleration according to specific parameters.

While the subject matter has been described in detail with reference to exemplary embodiments thereof, it will be apparent to one skilled in the art that various changes can be made, and equivalents employed, without departing from the scope of the invention. All related art references discussed in the above Description of the Related Art section are hereby incorporated by reference in their entirety.

What is claimed is:

1. An accelerator pedal assembly of a vehicle comprising:
a pivotable arm including a moveable end that is movable through a plurality of pedal positions from an initial position to a fully engaged position;
a pedal connected to the moveable end of the pivotable arm; and
a reaction force control assembly connected to the pivotable arm and configured to apply a reaction force to the pivotable arm, the reaction force control assembly including:
a first mode in which the reaction force increases as the pedal position approaches the fully engaged position in accordance with a first relationship; and
a second mode in which the reaction force increases as the pedal position approaches the fully engaged position in accordance with a second relationship that is different from the first relationship, and the second relationship is based on a driver positioning setting.

2. The accelerator pedal assembly of claim 1, wherein the second relationship is based on an adjustable driver seat height of the vehicle, and the reaction force control assembly operates in the second mode upon adjusting the driver seat height.

3. The accelerator pedal assembly of claim 2, wherein the second relationship is defined by a reduced reaction force for a predetermined pedal position for a lowered driver seat height.

4. An accelerator pedal assembly of a vehicle comprising:
a pivotable arm including a moveable end that is movable through a plurality of pedal positions from an initial position to a fully engaged position;
a pedal connected to the moveable end of the pivotable arm; and
a reaction force control assembly connected to the pivotable arm and configured to apply a reaction force to the pivotable arm, the reaction force control assembly including:
a first mode in which the reaction force increases as the pedal position approaches the fully engaged position in accordance with a first relationship; and
a second mode in which the reaction force increases as the pedal position approaches the fully engaged position in accordance with a second relationship that is different from the first relationship, and the second relationship is based on a selectable autonomous or semi-autonomous setting of the vehicle.

5. The accelerator pedal assembly of claim 4, wherein the second relationship is defined by an increased reaction force for a predetermined pedal position, and the reaction force control assembly operates in the second mode when the vehicle is operating in an autonomous driving mode.

6. The accelerator pedal assembly of claim 5, wherein second relationship is defined by a first rate of increase for a first range of predetermined pedal positions, followed by a second rate of increase that is less than the first rate for a second range of predetermined pedal positions that is closer to the fully engaged position than the first range.

7. The accelerator pedal assembly of claim 4, wherein the second relationship is defined by a decreased reaction force for a first range of predetermined pedal positions, followed by an increased reaction force for a second range of predetermined pedal positions that is closer to the fully engaged position than the first range, and the reaction force control assembly operates in the second mode when the vehicle is operating in an autonomous cruise control mode.

8. The accelerator pedal assembly of claim 7, wherein movement of the pivotable arm within the first range of predetermined pedal positions maintains output torque of the vehicle, and movement of the pivotable arm through the second range of predetermined pedal positions returns the reaction force control assembly to the first mode and thereby disables the autonomous cruise control mode.

9. An accelerator pedal assembly of a vehicle comprising:
a pivotable arm including a moveable end that is movable through a plurality of pedal positions from an initial position to a fully engaged position;
a pedal connected to the moveable end of the pivotable arm; and
a reaction force control assembly connected to the pivotable arm and configured to apply a reaction force to the pivotable arm, the reaction force control assembly including:
a first mode in which the reaction force increases as the pedal position approaches the fully engaged position in accordance with a first relationship; and
a second mode in which the reaction force increases as the pedal position approaches the fully engaged position in accordance with a second relationship that is different from the first relationship, and the second relationship is based on a dynamic vehicle condition.

10. The accelerator pedal assembly of claim 9, wherein the second relationship is defined by a decreased reaction force for a predetermined pedal position, and the reaction force control assembly operates in the second mode when the vehicle is ascending an incline.

11. The accelerator pedal assembly of claim 9, wherein the second relationship is defined by a decreased reaction force for a predetermined pedal position, and the reaction force control assembly operates in the second mode when the vehicle is navigating a curve.

12. The accelerator pedal assembly of claim 9, wherein the second relationship is defined by a decreased reaction force for a predetermined pedal position, and the reaction force control assembly operates in the second mode when the vehicle is traveling beyond a threshold speed.

13. The accelerator pedal assembly of claim 9, wherein the second relationship is defined by a decreased reaction force for a predetermined pedal position, and the reaction force control assembly operates in the second mode when the vehicle is traveling over a surface exhibiting a reduced coefficient of friction.

14. An accelerator pedal assembly of a vehicle comprising:
a pivotable arm including a moveable end that is movable through a plurality of pedal positions from an initial position to a fully engaged position;
a pedal connected to the moveable end of the pivotable arm; and
a reaction force control assembly connected to the pivotable arm and configured to apply a reaction force to the pivotable arm,
wherein the reaction force is defined by a first rate of increase for a first range of predetermined pedal positions, followed by a second rate of increase that is greater than the first rate for a second range of predetermined pedal positions that is closer to the fully engaged position than the first range.

15. The accelerator pedal assembly of claim 14, wherein the first rate of increase is linear.

16. The accelerator pedal assembly of claim 15, wherein the second rate of increase is nonlinear.

17. The accelerator pedal assembly of claim 16, wherein movement of the pivotable arm through the second range of predetermined pedal positions causes the vehicle to shift gears.

18. An accelerator pedal assembly of a vehicle comprising:
a pivotable arm including a moveable end that is movable through a plurality of pedal positions from an initial position to a fully engaged position;
a pedal connected to the moveable end of the pivotable arm; and
a reaction force control assembly connected to the pivotable arm and configured to apply a reaction force to the pivotable arm, the reaction force control assembly including:
a first mode in which the reaction force increases as the pedal position approaches the fully engaged position in accordance with a first relationship; and
a second mode in which the reaction force increases as the pedal position approaches the fully engaged position in accordance with a second relationship that is different from the first relationship, and the second relationship is based on a selectable sport setting of the vehicle and is defined by a first rate of increase for a first range of predetermined pedal positions, followed by a second rate of increase that is less than the first rate of increase for a second range of predetermined pedal positions that is closer to the fully engaged position than the first range.

19. The accelerator pedal assembly of claim 18, wherein the second relationship is defined by a third rate of increase that is greater than the second rate of increase for a third range of predetermined pedal positions that is closer to the fully engaged position than the second range.

20. The accelerator pedal assembly of claim 19, wherein movement of the pivotable arm through the third range of predetermined pedal positions causes the vehicle to shift gears.
